(19) United States
(12) Patent Application Publication
(10) Pub. No.: US 2026/0051096 A1
(43) Pub. Date: Feb. 19, 2026

(54) VIDEO EDITING METHOD, DEVICE, AND MEDIUM

(71) Applicant: Beijing Zitiao Network Technology Co., Ltd., Beijing (CN)

(72) Inventors: Anfeng HE, Beijing (CN); Zhichao ZHOU, Beijing (CN); Dongliang HE, Beijing (CN); Haiyu ZHAO, Beijing (CN); Zhiqin ZHAN, Beijing (CN); Xinglong WU, Beijing (CN); Haoran ZHANG, Beijing (CN); Lei SUN, Beijing (CN); Wei ZHANG, Beijing (CN)

(21) Appl. No.: 19/299,718

(22) Filed: Aug. 14, 2025

(30) Foreign Application Priority Data
Aug. 15, 2024 (CN) 202411125395.8

(51) Int. Cl. G06T 11/60; G06N 3/08; G06V 10/77

(52) U.S. Cl. CPC G06T 11/60; G06N 3/08; G06V 10/7715

(57) ABSTRACT

Embodiments of the present disclosure provide a video editing method, apparatus, device, medium and program product. The method includes: inputting an original video into a script generation model that is pre-trained; generating, by the script generation model, a video feature sequence according to video frames in the original video, mapping the video feature sequence to a text feature space of the script generation mode, and obtaining a video mapping feature sequence; generating, by the script generation model, a second video script of the original video based on the video mapping feature sequence, wherein the second video script includes a timestamp; adding the second video script to the original video according to the timestamp to obtain a target video

### CROSS-REFERENCE TO RELATED APPLICATION

This application claims the priority to and benefits of the Chinese Patent Application, No. 202411125395.8, which was filed on Aug. 15, 2024. The aforementioned patent application is hereby incorporated by reference in its entirety.

### TECHNICAL FIELD

Embodiments of the present disclosure relate to a video editing method, a device and a medium.

### BACKGROUND

With the development of computer and network technology, more and more users record daily life scenes by shooting videos, and share the shot videos with others.

Currently, such videos that record scenes such as daily life usually contain video script. High-quality video script can increase the fun and attractiveness of videos, thus increasing the spread of videos. However, the creation of video script has higher requirements for video authors and requires a certain foundation of script creation, which increases the difficulty of video creation.

### SUMMARY

Embodiments of the present disclosure provide a video editing method, an apparatus, a device, a medium, and a program product.

According to a first aspect, an embodiment of the present disclosure provides a video editing method, the method includes:
inputting an original video into a script generation model that is pre-trained, wherein the script generation model is trained based on video samples, and first video scripts of the video samples satisfy a preset selection condition;
generating, by the script generation model, a video feature sequence according to video frames in the original video, mapping the video feature sequence to a text feature space of the script generation mode, and obtaining a video mapping feature sequence;
generating, by the script generation model, a second video script of the original video based on the video mapping feature sequence, wherein the second video script comprises a timestamp;
adding the second video script to the original video according to the timestamp to obtain a target video.

According to a second aspect, an embodiment of the present disclosure further provides a video editing apparatus, the apparatus includes:
a video input module, configured to input an original video into a script generation model that is pre-trained, wherein the script generation model is trained based on video samples, and first video scripts of the video samples satisfy a preset selection condition;
a feature mapping module, configured to generate, by the script generation model, a video feature sequence according to video frames in the original video, map the video feature sequence to a text feature space of the script generation mode, and obtain a video mapping feature sequence;
a model output module, configured to generate, by the script generation model, a second video script of the original video based on the video mapping feature sequence, wherein the second video script comprises a timestamp;
a video generation module, configured to add the second video script to the original video according to the timestamp to obtain a target video.

In a third aspect, an embodiment of the present disclosure further provides an electronic device, the electronic device includes:
one or more processors;
a storage apparatus, configured to store one or more programs,
when the one or more programs are executed by the one or more processor, the one or more processors are caused to implement the video editing method according to any embodiment of the present disclosure.

In a fourth aspect, embodiments of the present disclosure also provide a storage medium including computer-executable instructions, wherein the computer-executable instructions, when executed by a computer processor, are used to perform the video editing method according to any embodiment of the present disclosure.

According to a fifth aspect, an embodiment of the present disclosure further provides a computer program product including a computer program, and when executed by the processor, the computer program implements the video editing method according to any embodiment of the present disclosure.

### BRIEF DESCRIPTION OF DRAWINGS

The above and other features, advantages, and aspects of various embodiments of the present disclosure will become more apparent when taken in conjunction with the accompanying drawings and referring to of the following Detailed Description. Throughout the drawings, the same or similar reference numerals denote the same or similar elements. It should be understood that the drawings are schematic and that originals and elements are not necessarily drawn to scale.

FIG. 1 is a schematic diagram of a video editing flow according to an embodiment of the present disclosure;

FIG. 2 is a schematic framework diagram of a script generation model according to an embodiment of the present disclosure;

FIG. 3 is a schematic diagram of another video editing flow according to an embodiment of the present disclosure;

FIG. 4 is a schematic diagram of another video editing flow according to an embodiment of the present disclosure;

FIG. 5 is a schematic structural diagram of a video editing apparatus according to an embodiment of the present disclosure;

FIG. 6 is a schematic structural diagram of an electronic device according to an embodiment of the present disclosure.

### DETAILED DESCRIPTION

Embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein, but are provided for a more thorough and complete understanding of the present disclosure. It should be understood that the drawings and embodiments of the present disclosure are for illustrative purposes only, and are not intended to limit the scope of protection of the present disclosure.

It should be understood that the various steps described in the method embodiments of the present disclosure may be performed in different orders, and/or in parallel. Furthermore, method embodiments may include additional steps and/or omit performing the illustrated steps. The scope of the present disclosure is not limited in this respect.

As used herein, the term “comprising” and variations thereof are open-encompassing, i.e., “including but not limited to”. The term “based on” is “based at least in part on”. The term “one embodiment” means “at least one embodiment”; the term “another embodiment” means “at least one additional embodiment”; the term “some embodiments” means “at least some embodiments”. Relevant definitions of other terms will be given in the following description.

It should be noted that the concepts such as “first” and “second” mentioned in the present disclosure are only used to distinguish different devices, modules, or units, and are not used to limit the order or interdependence of functions performed by these devices, modules, or units.

It should be noted that the modifications of “one” and “a plurality” mentioned in the present disclosure are schematic and not limiting, and should be understood by those skilled in the art as “one or more” unless otherwise explicitly indicated in the context.

The names of messages or information interacted between multiple devices in embodiments of the present disclosure are for illustrative purposes only, and are not intended to limit the scope of these messages or information.

It can be understood that before using the technical solutions disclosed in each embodiment of the present disclosure, users should be informed of the types, usage scope, usage scenarios, etc. of the personal information involved in the present disclosure in an appropriate manner in accordance with relevant laws and regulations, and authorization from the users should be obtained.

For example, in response to receiving an active request from the user, prompt information is sent to the user to explicitly prompt the user that the operation it requests to perform will require the acquisition and use of the user's personal information. Accordingly, the user can autonomously select whether or not to provide personal information to software or hardware such as electronic device, application, a server, or storage medium that performs the operation of the technical solution of the present disclosure according to prompt information.

As an optional but non-limiting implementation, in response to receiving an unsolicited request from the user, the manner of sending prompt information to the user may be, for example, the manner of pop-up window, and the pop-up window may be presented in text in the prompt information. In addition, the pop-up window can also carry an optional control for users to choose “agree” or “disagree” to provide personal information to electronic device.

It is to be understood that the above-described procedures of notifying and obtaining user authorization are merely illustrative and do not limit the implementation forms of the present disclosure, and other methods satisfying relevant laws and regulations can also be applied to the implementation forms of the present disclosure.

It can be understood that the data involved in this technical solution (including but not limited to the data itself, the acquisition or use of data) should comply with the requirements of corresponding laws, regulations and relevant provisions.

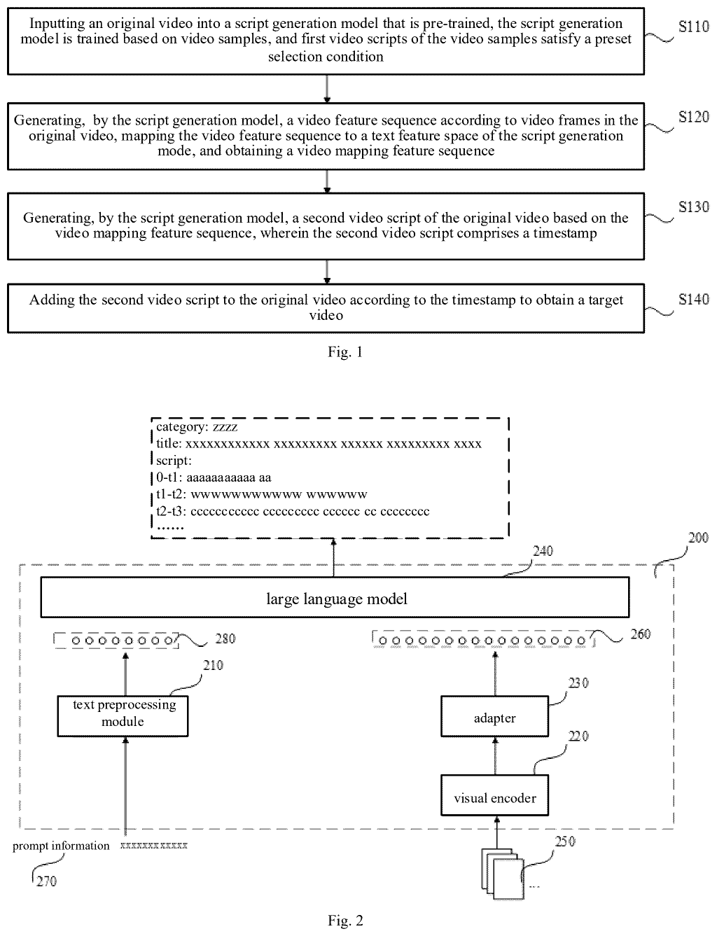

FIG. 1 is a schematic diagram of a video editing flow according to an embodiment of the present disclosure, and the embodiment of the present disclosure is applicable to a situation in which a video script is generated, for example, a scenario in which a script is automatically generated for a shot original video. The method may be performed by a video editing apparatus, which may be implemented in the form of software and/or hardware, or optionally, by an electronic device, which may be a mobile terminal, a PC side, a server, or the like.

As shown in FIG. 1, the method includes:
S110: inputting an original video into a script generation model that is pre-trained, wherein the script generation model is trained based on video samples, and first video scripts of the video samples satisfy a preset selection condition.

The original video may be a video frame sequence for which the script generation operation is to be performed. Original video may be a video shot by the user, or a video generated based on the picture provided by the user, etc. Embodiments of the present disclosure do not specifically limit a method of generating original video. Original video can be any video format, for example, MP4, AVI, MKV, or WMV formats. Original video can include video image and audio messages. Alternatively, the original video may not include audio information, and the embodiments of the present disclosure do not specifically limit this.

In some embodiments, the script generation model may be a multi-modal large model. Script generation model can include a visual encoder, an adapter, and a script generation module, etc. The visual encoder can represent a neural network model that compresses video frames into low-dimensional feature vectors, and the adapter may represent a neural network model that maps feature vectors in a visual feature space to a text feature space. The parameters of the adapter are updated during the training process of the script generation model. The script generation module may be a large language model, etc. The parameters of the script generation module are updated during the training process of the script generation model. The large language model is a pre-trained language model obtained by pre-training using large-scale corpus data, and is one of the methods of natural language processing. The large language model is a deep learning model trained on a huge data set to understand human language. In an embodiment of the present disclosure, large language model is used to understand the content of original video and generate script strongly related to the content of original video.

Optionally, prompt information, which characterizes the appeal of the video author, can also be input to the script generation model, so that the large language model is conditioned on the video creation appeal, understands the content of the original video, and generates script that is strongly related to the content of the original video. For example, the video script of the video sample used to train the script generation model in the embodiment of the present disclosure can be represented as the first video script of the video sample. Accordingly, the script generation model may further include a text preprocessing module which is used to map text information into text feature space, that is, to vectorize text information and obtain features that can be understood by large language models.

In an embodiment of the present disclosure, the script generation model is trained based on video samples in which the first video scripts satisfy a preset selection condition. Existing high-quality videos can be used as video samples, training dataset can be built based on the video samples, and drive script generation model can be driven to learn the corresponding relationship between video frames, prompt information and video scripts. It is understandable that the more concentrated data amount in training data and the higher the data quality, the better the model effect can be. The selection conditions may be set preferentially to filter out high-quality videos from existing videos. The selection conditions may be set according to actual application scenarios, and the embodiments of the present disclosure do not specifically limit them.
S120, generating, by the script generation model, a video feature sequence according to video frames in the original video, mapping the video feature sequence to a text feature space of the script generation mode, and obtaining a video mapping feature sequence.

In an embodiment of the present disclosure, the video feature sequence may represent a sequence of video features. Video features in the video feature sequence are features that represent original video in chronological order. The video feature can be understood as the feature vector obtained by video frame through encoding. Video features can be obtained through encoding video frames.

The features in text feature space are features that large language model can understand. For example, features in the text feature space represent tokens (hereinafter denoted as Token) that large language model can understand and generate. Token is assigned numerical values or identifiers, arranged in sequences or vectors, and is input into or output from the model, which is the linguistic building block of the model. Tokens can be seen as fragments of words that are not precisely split from the beginning or end of the word, and can include trailing spaces as well as sub-words, or even larger linguistic units. Token acts as a bridge between raw text data and digital representations that can be used by large language model. Large language model uses Token to ensure coherence and conformance of the text.

The video mapping feature sequence represents a sequence of mapping features corresponding to video features in the text feature space. A pre-trained adapter can be used to map the video features in the video feature sequence to the text feature space to obtain mapping features. The mapping features are arranged in the time sequence of the video frames to obtain a video mapping feature sequence. In order to make the video feature sequence understandable to the large language model, a pre-trained adapter can be used to map the video feature sequence to the text feature space of the large language model to obtain a video mapping feature sequence.

Exemplarily, the generating, by the script generation model, a video feature sequence according to video frames in the original video, mapping the video feature sequence to a text feature space of the script generation mode, and obtaining a video mapping feature sequence includes: compressing the video frames in the original video by the visual encoder to obtain a feature vector, and generating the video feature sequence according to the feature vector corresponding to the video frames. Mapping the video feature sequence to the text feature space by the adapter to obtain the video mapping feature sequence.

Visual encoder extracts the video features of each video frame to form a video feature sequence. For example, for video frames of the original video, visual encoder divides video frames into image data block, and compresses all image data block into low-dimensional vectors to obtain the feature vector corresponding to video frames. Combining the feature vector corresponding to each video frame to obtain the video feature sequence.

Specifically, original video is input into visual encoder, at least one video frames are extracted from the original video by a visual encoder in a uniform sampling manner. For the extracted video frames, the video frames are divided into image data blocks, all the image data blocks are compressed into low-dimensional vectors, and a feature vector corresponding to the video frame is obtained. The visual encoder combines the feature vectors corresponding to each video frame according to the time sequence of the video frames to obtain a video feature sequence.

Then, the video feature sequence is input to an adapter, and a video mapping feature sequence is generated by the adapter. For example, the adapter may be a linear model, and the video features corresponding to each video frame of the video feature sequence are processed according to the linear mapping relationship of the adapter itself to obtain the video mapping features corresponding to the video frame. Generating a video mapping feature sequence based on the video mapping features corresponding to each video frame in the original video. It can solve the problem of error or error accumulation caused by the related technology in which the video description is first generated for video frame in the video sequence based on the video description recognition model, and then the video description is input into the large language model to obtain the script. Since the embodiment of the present disclosure directly maps the video feature sequence to the text feature space, there is no step of understanding the video content and generating the video description, and it is possible to avoid the problem that the video description is inaccurate due to the error or error in the video understanding, and further, the accuracy of script generation is affected.
S130: generating, by the script generation model, a second video script of the original video based on the video mapping feature sequence, wherein the second video script comprises a timestamp.

For example, the video script of the original video generated by the script generation model can be represented as the second video script of the original video.

Second video script can be the text content that appears in the video. Second video script has the role of explaining the video, guiding the audience to interact, and enhancing the expression of the video's intent. For example, second video script can be understood as the narration of a video, etc.

Exemplarily, the generating, by the script generation model, a second video script of the original video based on the video mapping feature sequence includes: generating, the script text and timestamp of the corresponding video frame, by the script generation model, based on the video pictures represented by each feature vector in the video mapping feature sequence as the video script corresponding to the video frame, and determining the second video script of the original video based on the video script corresponding to the video frame in the original video.

Since script generation model has learned the knowledge of mapping relationship between video frame and video script, the second video script of the original video can be generated based on video mapping feature sequence by the script generation model.

Optionally, in order to generate a script that satisfies the expectations of the video author, the video author may also be provided with a prompt information input function to represent the video creation appeal of the video author through prompt information. Accordingly, the generating, by the script generation model, a second video script of the original video based on the video mapping feature sequence includes: inputting prompt information corresponding to the original video into the script generation model; generating, by the script generation model, the second video script of the original video based on the prompt information and the video mapping feature sequence.

Prompt information can represent the video author's demands for video creation. For example, prompt information may be a text that includes aspects such as script attribute prompt information and/or script content prompt information. After the prompt information is input into the script generation model, it is encoded by the text preprocessing module to obtain a feature vector sequence. The feature vector sequence can represent the Tokens sequence of the text feature space that can be understood by the large language model.

Since the script generation model learns the knowledge of the mapping relationship between the data pairs composed of the video frame and the prompt information and the video script, the script generation model can generate the second video script of the original video based on the prompt information and the video mapping feature sequence.

Optionally, the generating, by the script generation model, the second video script of the original video based on the prompt information and the video mapping feature sequence, includes: generating, by the script generation module, the second video script of the original video based on the video mapping feature sequence under constraint of the prompt information.

FIG. 2 is a schematic framework diagram of a script generation model according to an embodiment of the present disclosure. As shown in FIG. 2, the script generation model 200 includes a text preprocessing module 210, a visual encoder 220, an adapter 230, and a large language model 240. Original video 250 is input to script generation model 200, the video frames of the original video 250 are encoded by the visual encoder 220, and the video feature sequence is output to the adapter 230. The video feature sequence is mapped to the text feature space that can be understood by the large language model 240 by the adapter 230, and a video mapping feature sequence 260, i.e., video Tokens, is obtained. The prompt information 270 is input to the script generation model 200, and the prompt information 270 is encoded into a feature vector sequence 280 of the text feature space that can be understood by the large language model 240 by the preprocessing module 210, i.e., Text Tokens. The feature vector sequence 280 and the video mapping feature sequence 260 are spliced to be used as the input of the large language model 240, and the large language model 240 uses the feature vector sequence 280 as a condition to generate a second video copy based on the video mapping feature sequence 260, so that the video script satisfies the video creation requirements. The second video script of the original video can be generated through the above process. The video script, for example, the second video script of the original video may include the script content and the timestamp, and t1, t2, t3, . . . can be used to represent the timestamp.

For existing videos, the category to which the video belongs and the title of the video can be obtained. Optionally, script generation model can also be trained to have the ability to classify videos and generate titles according to the categories and titles of video samples. The original video is input into script generation model to generate categories and titles by script generation model. The category of the video can be used for video classification, and for recommending candidate timbres for original video, etc. The title of the video can be used as referring to for the video author to edit and generate the final video title, making it convenient to draft video titles.
S140: adding the second video script to the original video according to the timestamp to obtain a target video.

Timestamp is used to align second video script and original video's video frame. The timestamp of the second video script is determined based on the timestamp of the video frame represented by the script. Since the video feature sequence includes feature vectors arranged in time order, after feature mapping, the mapping features included in the video mapping feature sequence also have time attributes. The second video script with timestamp, video category and title are generated based on the video mapping feature sequence through the script generation model.

The video editing method provided by the embodiment of the present disclosure can conveniently generate video script that is strongly related to the video content, thereby reducing the difficulty of video creation and increasing the fun and attractiveness of the video.

Exemplarily, the video frame corresponding to the second video script is determined according to the timestamp corresponding to the second video script, and the second video script is added to the corresponding video frame to obtain the target video. For example, the video frame corresponding to the second video script is determined according to the timestamp corresponding to the second video script, the second video script is rendered to the corresponding video frame, and the title is rendered to the set position of each video frame to obtain the target video. In addition, the second video script is converted into audio data, and the timbre corresponding to the audio data is determined based on the video category. The target video is played in combination with the audio data and the video data.

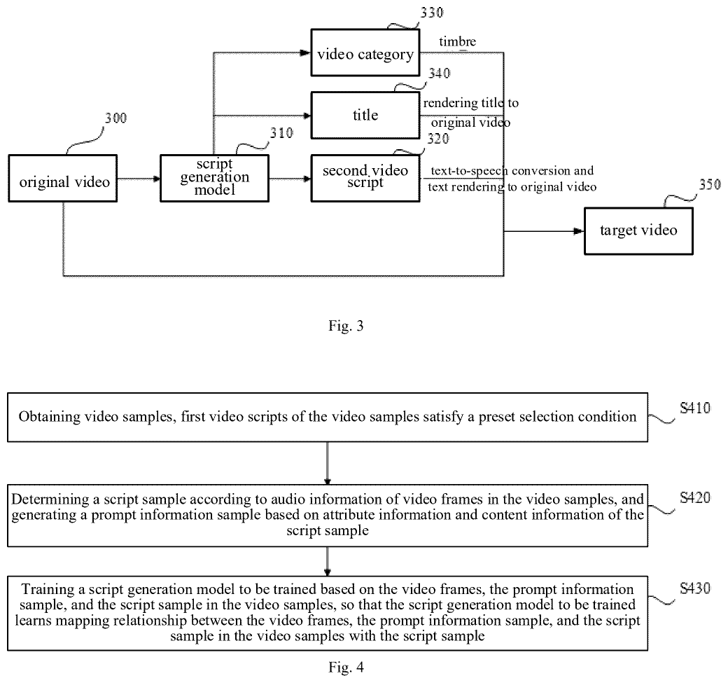

FIG. 3 is a schematic diagram of another video editing flow according to an embodiment of the present disclosure. As shown in FIG. 3, the original video 300 is input to the script generation model 310, and the second video script 320 output by the script generation model 310 is obtained, the second video script 320 has timestamp. The video category 330 and title 340 output by the script generation model 310 can also be acquired. Audio data is generated based on second video script 320 using text-to-speech technology. The target video 350 is determined in conjunction with audio data, second video script 320, and original video 300. The target video 350 is played to display the second video script 320 and the title 340 on the video frame of the target video 350, and the audio data is played with the timbre corresponding to the video category 330.

According to the technical solution of the embodiment of the present disclosure, video frames in the original video are compressed by the script generation model to obtain the video frame feature sequence, the video frame feature sequence is mapped to a text feature space to obtain a video mapping feature sequence, and a second video script of the original video is generated based on the video mapping feature sequence. Since the vectorization of video frame and feature mapping are carried out in the same model, the accumulation of errors or errors can be avoided. Then, the second video script output by script generation model is obtained, and add the second video script to original video according to timestamp to get the target video. Embodiments of the present disclosure realize the automatic generation of video script related to video content and satisfying expectations, and solve the problem of high difficulty in creating video script in related technologies. According to the embodiment of the present disclosure, video script strongly related to video content can be conveniently generated, and the target video can be obtained by rendering the video script to original video, so that the target video has higher interest and attractiveness.

FIG. 4 is a schematic diagram of another video editing flow according to an embodiment of the present disclosure. On the basis of the above-described embodiments, an embodiment of the present disclosure defines a training method for script generation model in an attachment. The method includes:
S410: obtaining the video samples, the first video scripts of the video samples satisfy the preset selection condition.

In the embodiment of the present disclosure, the selection condition may be determined in combination with common vocabulary, the number of likes, the number of collections, the number of forwards, and the like. Then, high-quality videos are selected from the submitted videos based on the selection conditions as video samples.
S420, determining a script sample according to audio information of video frames in the video samples, and generating a prompt information sample based on attribute information and content information of the script sample.

Exemplarily, deconstructing the video samples into the form of triplet, and triplet could include video frame, prompt information, and script. For example, uniform frame extraction processing is performed on video samples to obtain video frame in video samples. Alternatively, all video frame included in the video may be regarded as video frame in the video sample, and the present disclosure does not specifically limit this. Perform audio recognition on the video frame to obtain the audio information of the video frame as the script sample. Then, perform word segmentation on the script sample to obtain the keywords included in the script sample. Determine the script content prompt information based on the keywords. For example, keywords may include words such as subject, object, price, product, and store. Determine the script attribute prompt information based on the attributes of the script sample. For example, the attributes include fast script, slow script, dense script, or sparse script. Splice the script attribute prompt information and the script content prompt information to obtain a prompt information sample.
S430: training a script generation model to be trained based on the video frames in the video samples, the prompt information sample, and the script sample, so that the script generation model to be trained learns a mapping relationship among the video frames in the video samples, the prompt information sample, and the script sample.

The script generation model to be trained includes text preprocessing module, visual encoder, adapter and large language model, etc. The model parameters of adapter and large language model need to be updated in the process of training script generation model, and the model parameters of preprocessing module and visual encoder remain unchanged.

Exemplarily, inputting the video frames in the video samples and corresponding prompt information samples into the script generation model to be trained, and obtaining a predicted script output by the script generation model to be trained; calculating a loss value between the predicted script and the script sample; in response to the loss value not satisfying a model training end condition, adopting a backpropagation method to adjust model parameters of the script generation model to be trained.

Specifically, the video frames in the video samples and the corresponding prompt information samples are input into the script generation model to be trained. Video frame in the video sample is abstracted into feature vector by visual encoder, and the video feature sequence is formed according to the video frame corresponding to each feature vector. These feature vector can be understood as visual keyword (visual words) of visual feature space. The feature vector included in the video feature sequence is mapped to the text feature space by the adapter, and the feature mapping vector is obtained. The video mapping feature sequence is constructed according to the feature mapping vector. That is, the visual words in the visual feature space are mapped into a sequence of Tokens in the text feature space through the adapter, which becomes a feature that can be understood by the large language model. The prompt information sample is abstracted into a sequence of Tokens in the text feature space that can be understood by the large language model through the text preprocessing module. The Tokens are understood by the large language model to generate a predicted script. The loss value of the predicted script corresponding to the video sample and the script sample is calculated. The loss function can be a mean square error function, a binary cross entropy function or a cross entropy function, etc., and the embodiment of the present disclosure does not make specific restrictions on this. If the loss value does not meet the end condition of the model training, the parameters of the adapter and the parameters of the large language model in the script generation model to be trained are adjusted by backpropagation. Then, based on the adjusted script generation model, the predicted script is continued to be generated based on the video sample and the prompt information sample. If the loss value meets the end condition of the model training, the training is terminated to obtain a trained script generation model.

The script generation model according to the embodiment of the present disclosure uses the script of high-quality videos as a direct prediction target to perform model training, thereby reducing the training error of the model and achieving a global optimal effect. In the related art, a video description is first generated for video frame in a video sequence based on a video description recognition model, and then the video description is input into large language model to obtain a script, and the video description is optimized in recognition model and large language model respectively. In the related art, the optimization of each model is local optimization. During the optimization of each model, it is difficult to obtain the correctly labeled data (groundtruth) of the intermediate process, and the optimization of the model cannot achieve the global optimal effect. In the embodiment of the present disclosure, the model optimization takes the script sample corresponding to the video sample as groundtruth, that is, the video script of the high-quality video is used as the direct prediction target training script generation model, and the global optimal effect can be achieved.

According to the technical solution of the embodiment of the present disclosure, by screening high-quality videos among existing videos, taking script of high-quality videos as prediction targets, and performing model training in combination with high-quality videos, script, and prompt information, script generation model can learn video frame of prompt information, mapping relationship, and script, and realize convenient and accurate training of script generation model.

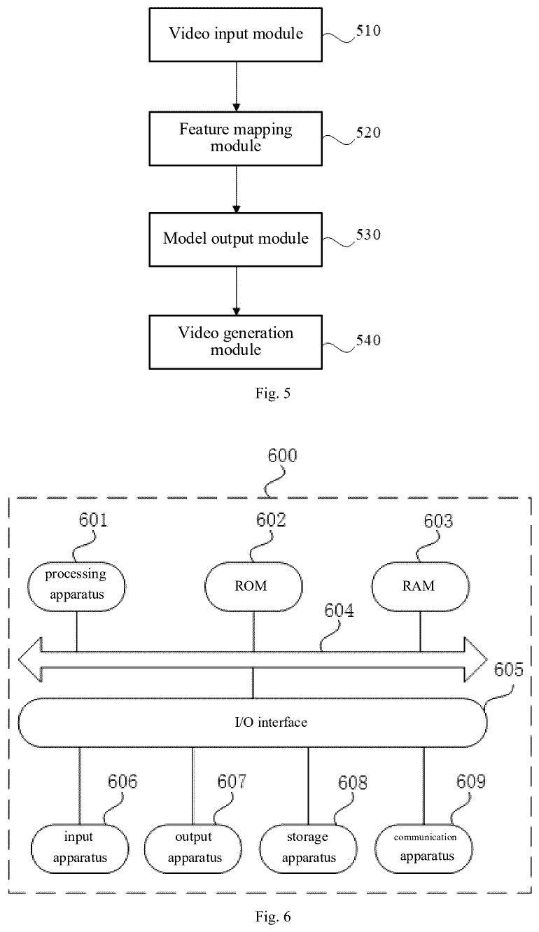

FIG. 5 is a schematic structural diagram of a video editing device according to an embodiment of the present disclosure, and the device may be implemented in the form of software and/or hardware, or optionally, by an electronic device, and the electronic device may be a mobile terminal, a PC, a server, or the like.

As shown in FIG. 5, the apparatus includes a video input module 510, a feature mapping module 520, a model output module 530, and a video generation module 540.

The video input module 510 is configured to input an original video into a script generation model that is pre-trained, the script generation model is trained based on video samples, and first video scripts of the video samples satisfy a preset selection condition;

the feature mapping module 520 is configured to generate, by the script generation model, a video feature sequence according to video frames in the original video, map the video feature sequence to a text feature space of the script generation mode, and obtaining a video mapping feature sequence;

the model output module 530 is configured to generate, by the script generation model, a second video script of the original video based on the video mapping feature sequence, wherein the second video script comprises a timestamp;

the video generation module 540 is configured to add the second video script to the original video according to the timestamp to obtain a target video.

Optionally, the model output module 530 is specifically configured to:
input prompt information corresponding to the original video into the script generation model;
generate, by the script generation model, the second video script of the original video based on the prompt information and the video mapping feature sequence.

Further, the script generation model includes script generation module, and parameters of the script generation module are updated during the training process of the script generation model;
the generating, by the script generation model, the second video script of the original video based on the prompt information and the video mapping feature sequence includes:
generating, by the script generation module, the second video script of the original video based on the video mapping feature sequence under constraint of the prompt information, wherein the prompt information comprises script attribute prompt information and/or script content prompt information.

Optionally, the training method of the script generation model includes:
obtaining the video samples, wherein the first video scripts of the video samples satisfy the preset selection condition;
determining a script sample according to audio information of video frames in the video sample s, and generating a prompt information sample based on attribute information and content information of the script sample;
training a script generation model to be trained based on the video frames in the video samples, the prompt information sample, and the script sample, so that the script generation model to be trained learns a mapping relationship among the video frames in the video samples, the prompt information sample, and the script sample.

Further, the training a script generation model to be trained based on the video frames in the video samples, the prompt information sample, and the script sample includes:
inputting the video frames in the video samples and corresponding prompt information samples into the script generation model to be trained, and obtaining a predicted script output by the script generation model to be trained;
calculating a loss value between the predicted script and the script sample;
in response to the loss value not satisfying a model training end condition, adopting a backpropagation method to adjust model parameters of the script generation model to be trained.

Optionally, the script generation model includes a visual encoder and an adapter, and parameters of the adapter are updated during training of the script generation model;

The feature mapping module 520 is specifically used to:
compress the video frames in the original video by the visual encoder to obtain a feature vector, and generating the video feature sequence according to the feature vector corresponding to the video frames;
map the video feature sequence to the text feature space by the adapter to obtain the video mapping feature sequence.

Optionally, the video generation module 540 is specifically used to:
determine a video frame corresponding to the second video script according to a timestamp corresponding to the second video script, add the second video script to the video frame corresponding to the second video script, and obtaining the target video.

The video editing apparatus according to the embodiment of the present disclosure can execute the video editing method according to any embodiment of the present disclosure, and has functional modules and beneficial effects corresponding to the execution method.

It is worth noting that each unit and module included in the above-described device only performs split according to the functional logic, but is not limited to the above-described split, as long as the corresponding functions can be realized; in addition, the specific names of each functional unit are only for convenience of mutual distinction, and are not used to limit the scope of protection of the embodiments of the present disclosure.

FIG. 6 is a schematic structural diagram of an electronic device according to an embodiment of the present disclosure. Referring to of FIG. 6 below shows a schematic structural diagram of a electronic device (such as the terminal device or server in FIG. 6) 600 suitable for implementing embodiments of the present disclosure. The terminal device in the embodiment of the present disclosure may include, but is not limited to, a mobile terminal such as a mobile phone, a notebook computer, a digital broadcast receiver, a PDA (personal digital assistant), a PAD (Tablet PC), a PMP (Portable Multimedia Player), an in-vehicle terminal (for example, an in-vehicle navigation terminal), and the like, and a fixed terminal such as a digital TV, a desktop computer, and the like. The electronic device illustrated in FIG. 6 is merely an example, and should not impose any limitation on the functionality and scope of use of the embodiments of the present disclosure.

As shown in FIG. 6, the electronic device 600 may include a processing apparatus (e.g., central processing unit, graphics processing unit, etc.) 601 that may perform various appropriate actions and processes according to a program stored in the read-only memory (ROM) 602 or a program loaded from the storage apparatus 608 into the random-access memory (RAM) 603. In the RAM 603, various programs and data necessary for the operation of the electronic device 600 are also stored. The processing apparatus 601, the ROM 602, and the RAM 603 are connected to each other by a bus 604. An edit/output (I/O) interface 605 is also connected to the bus 604.

Generally, the following devices may be connected to the I/O interface 605: touchpad 606 including, for example, touchscreen, accelerometer, keyboard, mouse, camera, microphone, gyroscope, input apparatus, etc.; an output apparatus 607 including, for example, a liquid crystal display (LCD), a speaker, a vibrator, and the like; storage apparatus 608 including, for example, magnetic tape, hard disk, etc.; and communication apparatus 609. The communication apparatus 609 may allow the electronic device 600 to communicate wirelessly or wired with other devices to exchange data. While FIG. 6 shows an electronic device 600 with various devices, it should be understood that it is not required that all of the devices shown be implemented or provided. More or fewer devices may alternatively be implemented or provided.

In particular, according to embodiments of the present disclosure, the process described above in the referring to flowchart may be implemented as a computer software program. For example, embodiments of the present disclosure include a computer program product including a computer program carried on a non-transitory computer-readable medium, the computer program containing program code for performing the method shown in the flowchart. In such embodiments, the computer program may be downloaded and installed from the network via communication apparatus 609, or installed from storage apparatus 608, or installed from ROM 602. When the computer program is executed by the processing apparatus 601, the above-described functions defined in the method of the embodiment of the present disclosure are executed.

The names of messages or information interacted between multiple devices in embodiments of the present disclosure are for illustrative purposes only, and are not intended to limit the scope of these messages or information.

The electronic device provided by the embodiment of the present disclosure and the video editing method provided by the above-described embodiment belong to the same inventive concept, and the technical details not described in detail in the present embodiment can be referred to the above-described embodiment, and the present embodiment has the same beneficial effects as the above-described embodiment.

Embodiments of the present disclosure provide a computer storage medium having a computer program stored thereon, and when the program is executed by a processor, the video editing method provided by the above embodiment is implemented.

It should be noted that, the computer-readable medium of the present disclosure may be a computer-readable signal medium, a computer-readable storage medium, or any combination thereof. The computer-readable storage medium may be, for example, but is not limited to, an electrical, magnetic, optical, electromagnetic, infrared, or semiconductor system, apparatus, or device, or a combination of any of the above. More specific examples of computer-readable storage medium may include, but are not limited to, electrical connections with one or more wires, portable computer magnetic disk, hard disk, random access memory (RAM), read-only memory (ROM), erasable programmable read-only memory (EPROM or Flash), optical fiber, portable compact disc read-only memory (CD-ROM), optical storage device, magnetic storage device, or any suitable combination of the foregoing. In the present disclosure, computer-readable storage medium may be any tangible medium containing or storing a program that may be used by or in conjunction with an instruction execution system, apparatus, or device. Whereas in the present disclosure, a computer-readable signal medium may include a data signal propagated in a baseband or as part of a carrier wave, carrying computer-readable program code therein. Such propagated data signals may take a variety of forms, including, but not limited to, electromagnetic signals, optical signals, or any suitable combination of the foregoing. The computer-readable signal medium may also be any computer-readable medium other than the computer-readable storage medium that may transmit, propagate, or transmit a program for use by or in connection with an instruction execution system, apparatus, or device. The program code contained on the computer-readable medium may be transmitted using any suitable medium including, but not limited to, wires, optical cables, RF (radio frequency), or the like, or any suitable combination of the foregoing.

In some embodiments, the client, server may communicate using any currently known or future developed network protocol such as HTTP (HyperText Transfer Protocol), and may be interconnected with any form or medium of digital data communication (e.g., a communication network). Examples of communication networks include local area networks (“LAN”), wide area networks (“WAN”), the Internet (e.g., the Internet), and end-to-end networks (e.g., ad hoc end-to-end networks), as well as any currently known or future-developed networks.

The computer-readable medium may be included in the electronic device described above; it may also exist alone without being fitted into the electronic device.

The computer-readable medium carries one or more programs that, when executed by the electronic device, cause the electronic device to:
input an original video into a script generation model that is pre-trained, wherein the script generation model is trained based on video samples, and first video scripts of the video samples satisfy a preset selection condition;
generate, by the script generation model, a video feature sequence according to video frames in the original video, map the video feature sequence to a text feature space of the script generation mode, and obtaining a video mapping feature sequence;
generate, by the script generation model, a second video script of the original video based on the video mapping feature sequence, wherein the second video script comprises a timestamp;
add the second video script to the original video according to the timestamp to obtain a target video.

Computer program code for performing the operations of the present disclosure may be written in one or more programming languages, or combinations thereof, including, but not limited to, object-oriented programming languages such as Java, Smalltalk, C++, but also conventional procedural programming languages such as the “C” language or similar programming languages. The program code may be executed entirely on the user's computer, partially on the user's computer, as a standalone software package, partially on the user's computer and partially on a remote computer, or entirely on a remote computer or server. In cases involving a remote computer, the remote computer may be connected to the user computer through any kind of network, including a local area network (LAN) or a wide area network (WAN), or may be connected to an external computer (e.g., using an Internet service provider to connect over the Internet).

Flowcharts and block diagrams in the drawings illustrate the architecture, functionality, and operation of possible implementations of systems, methods, and computer program product in accordance with various embodiments of the present disclosure. In this regard, each block in the flowchart or block diagram may represent a module, program segment, or portion of code that contains one or more executable instructions for implementing a specified logical function. It should also be noted that, in some alternative implementations, the functions noted in the blocks may also occur in a different order than that noted in the figures. For example, two blocks represented in succession may actually be executed substantially in parallel, and they may sometimes be executed in reverse order, depending on the function involved. It is also noted that each block in the block diagrams and/or flowchart diagrams, and combinations of blocks in the block diagrams and/or flowchart diagrams, may be implemented with a dedicated hardware-based system that performs the specified functions or operations, or may be implemented with a combination of dedicated hardware and computer instructions.

The units described in the embodiments of the present disclosure may be implemented by software or hardware. Here, the name of the unit does not constitute a limitation of the unit itself in some cases.

The functions described above herein may be performed, at least in part, by one or more hardware logic components. For example, and without limitation, exemplary types of hardware logic components that may be used include Field Programmable Gate Arrays (FPGA), Application Specific Integrated Circuits (ASIC), Application Specific Standard Products (ASSP), Systems on tile (SOC), Complex Programmable Logic Devices (CPLD), and the like.

In the context of the present disclosure, the machine-readable medium may be a tangible medium that may contain or store a program for use by or in conjunction with an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, devices, or devices, or any suitable combination of the foregoing. More specific examples of machine-readable storage medium may include electrical connections based on one or more lines, portable computer disks, hard disk, random access memory (RAM), read-only memory (ROM), erasable programmable read-only memory (EPROM or Flash memory), optical fiber, handy compact disk read-only memory (CD-ROM), optical storage devices, magnetic storage devices, or any suitable combination of the foregoing.

The above description is merely an explanation of preferred embodiments of the present disclosure and the technical principles employed. Those skilled in the art should understand that the scope of disclosure in the present disclosure is not limited to technical solutions formed by specific combinations of the above-described technical feature rights, and should also cover other technical solutions formed by arbitrary combinations of the above-described technical feature rights or their equivalent features without departing from the concept of the above-described disclosure. For example, the above-described features are mutually replaced with technical feature having similar functions disclosed in the present disclosure (but not limited to).

Furthermore, while operations are depicted in a particular order, this should not be understood as requiring the operations to be performed in the particular order shown or in a sequential order. Under certain circumstances, multi-task and parallel processing may be advantageous. Likewise, while several specific implementation details are included in the above discussion, these should not be construed as limiting the scope of the present disclosure. Certain features described in the context of separate embodiments may also be implemented in combination in a single embodiment. Conversely, the various features described in the context of a single embodiment may also be implemented in multiple embodiments individually or in any suitable sub-combination.

Although the subject matter has been described in language specific to structural features and/or methodological logical acts, it should be understood that the subject matter defined in the appended claims is not necessarily limited to the specific features or acts described above. Rather, the specific features and acts described above are merely exemplary forms for implementing the claims.

1. A video editing method, comprising:
inputting an original video into a script generation model that is pre-trained, wherein the script generation model is trained based on video samples, and first video scripts of the video samples satisfy a preset selection condition;
generating, by the script generation model, a video feature sequence according to video frames in the original video, mapping the video feature sequence to a text feature space of the script generation mode, and obtaining a video mapping feature sequence;
generating, by the script generation model, a second video script of the original video based on the video mapping feature sequence, wherein the second video script comprises a timestamp;
adding the second video script to the original video according to the timestamp to obtain a target video.

2. The method according to claim 1, wherein the generating, by the script generation model, a second video script of the original video based on the video mapping feature sequence comprises:
inputting prompt information corresponding to the original video into the script generation model;
generating, by the script generation model, the second video script of the original video based on the prompt information and the video mapping feature sequence.

3. The method according to claim 2, wherein the script generation model comprises a script generation module, and parameters of the script generation module are updated during training process of the script generation model;
the generating, by the script generation model, the second video script of the original video based on the prompt information and the video mapping feature sequence comprises:
generating, by the script generation module, the second video script of the original video based on the video mapping feature sequence under constraint of the prompt information, wherein the prompt information comprises script attribute prompt information and/or script content prompt information.

4. The method according to claim 2, wherein a training method of the script generation model comprises:
obtaining the video samples, wherein the first video scripts of the video samples satisfy the preset selection condition;
determining a script sample according to audio information of video frames in the video samples, and generating a prompt information sample based on attribute information and content information of the script sample;
training a script generation model to be trained based on the video frames in the video samples, the prompt information sample, and the script sample, so that the script generation model to be trained learns a mapping relationship among the video frames in the video samples, the prompt information sample, and the script sample.

5. The method according to claim 4, wherein the training a script generation model to be trained based on the video frames in the video samples, the prompt information sample, and the script sample comprises:
inputting the video frames in the video samples and corresponding prompt information samples into the script generation model to be trained, and obtaining a predicted script output by the script generation model to be trained;
calculating a loss value between the predicted script and the script sample;
in response to the loss value not satisfying a model training end condition, adopting a backpropagation method to adjust model parameters of the script generation model to be trained.

6. The method according to claim 1, wherein the script generation model comprises a visual encoder and an adapter, and parameters of the adapter are updated during training of the script generation model;
the generating, by the script generation model, a video feature sequence according to video frames in the original video, mapping the video feature sequence to a text feature space of the script generation mode, and obtaining a video mapping feature sequence comprises:
compressing the video frames in the original video by the visual encoder to obtain a feature vector, and generating the video feature sequence according to the feature vector corresponding to the video frames;
mapping the video feature sequence to the text feature space by the adapter to obtain the video mapping feature sequence.

7. The method according to claim 1, wherein the adding the second video script to the original video according to the timestamp to obtain a target video comprises:
determining a video frame corresponding to the second video script according to a timestamp corresponding to the second video script, adding the second video script to the video frame corresponding to the second video script, and obtaining the target video.

8. An electronic device, comprising:
one or more processors;
a storage apparatus, configured to store one or more programs,
wherein when the one or more programs are executed by the one or more processor, the one or more processors are caused to implement a video editing method, and the method comprises:
inputting an original video into a script generation model that is pre-trained, wherein the script generation model is trained based on video samples, and first video scripts of the video samples satisfy a preset selection condition;
generating, by the script generation model, a video feature sequence according to video frames in the original video, mapping the video feature sequence to a text feature space of the script generation mode, and obtaining a video mapping feature sequence;
generating, by the script generation model, a second video script of the original video based on the video mapping feature sequence, wherein the second video script comprises a timestamp;
adding the second video script to the original video according to the timestamp to obtain a target video.

9. The electronic device according to claim 8, wherein the generating, by the script generation model, a second video script of the original video based on the video mapping feature sequence comprises:
inputting prompt information corresponding to the original video into the script generation model;
generating, by the script generation model, the second video script of the original video based on the prompt information and the video mapping feature sequence.

10. The electronic device according to claim 9, wherein the script generation model comprises a script generation module, and parameters of the script generation module are updated during training process of the script generation model;
the generating, by the script generation model, the second video script of the original video based on the prompt information and the video mapping feature sequence comprises:
generating, by the script generation module, the second video script of the original video based on the video mapping feature sequence under constraint of the prompt information, wherein the prompt information comprises script attribute prompt information and/or script content prompt information.

11. The electronic device according to claim 9, wherein a training method of the script generation model comprises:
obtaining the video samples, wherein the first video scripts of the video samples satisfy the preset selection condition;
determining a script sample according to audio information of video frames in the video samples, and generating a prompt information sample based on attribute information and content information of the script sample;
training a script generation model to be trained based on the video frames in the video samples, the prompt information sample, and the script sample, so that the script generation model to be trained learns a mapping relationship among the video frames in the video samples, the prompt information sample, and the script sample.

12. The electronic device according to claim 11, wherein the training a script generation model to be trained based on the video frames in the video samples, the prompt information sample, and the script sample comprises:
inputting the video frames in the video samples and corresponding prompt information samples into the script generation model to be trained, and obtaining a predicted script output by the script generation model to be trained;
calculating a loss value between the predicted script and the script sample;
in response to the loss value not satisfying a model training end condition, adopting a backpropagation method to adjust model parameters of the script generation model to be trained.

13. The electronic device according to claim 8, wherein the script generation model comprises a visual encoder and an adapter, and parameters of the adapter are updated during training of the script generation model;
the generating, by the script generation model, a video feature sequence according to video frames in the original video, mapping the video feature sequence to a text feature space of the script generation mode, and obtaining a video mapping feature sequence comprises:
compressing the video frames in the original video by the visual encoder to obtain a feature vector, and generating the video feature sequence according to the feature vector corresponding to the video frames;
mapping the video feature sequence to the text feature space by the adapter to obtain the video mapping feature sequence.

14. The electronic device according to claim 8, wherein the adding the second video script to the original video according to the timestamp to obtain a target video comprises:
determining a video frame corresponding to the second video script according to a timestamp corresponding to the second video script, adding the second video script to the video frame corresponding to the second video script, and obtaining the target video.

15. A non-transitory storage medium comprising computer-executable instructions, inputting an original video into a script generation model that is pre-trained, wherein the script generation model is trained based on video samples, and first video scripts of the video samples satisfy a preset selection condition;
generating, by the script generation model, a video feature sequence according to video frames in the original video, mapping the video feature sequence to a text feature space of the script generation mode, and obtaining a video mapping feature sequence;
generating, by the script generation model, a second video script of the original video based on the video mapping feature sequence, wherein the second video script comprises a timestamp;
adding the second video script to the original video according to the timestamp to obtain a target video.

16. The non-transitory storage medium according to claim 15, wherein the generating, by the script generation model, a second video script of the original video based on the video mapping feature sequence comprises:
inputting prompt information corresponding to the original video into the script generation model;
generating, by the script generation model, the second video script of the original video based on the prompt information and the video mapping feature sequence.

17. The non-transitory storage medium according to claim 16, wherein the script generation model comprises a script generation module, and parameters of the script generation module are updated during training process of the script generation model;
the generating, by the script generation model, the second video script of the original video based on the prompt information and the video mapping feature sequence comprises:
generating, by the script generation module, the second video script of the original video based on the video mapping feature sequence under constraint of the prompt information, wherein the prompt information comprises script attribute prompt information and/or script content prompt information.

18. The non-transitory storage medium according to claim 16, wherein a training method of the script generation model comprises:
obtaining the video samples, wherein the first video scripts of the video samples satisfy the preset selection condition;
determining a script sample according to audio information of video frames in the video samples, and generating a prompt information sample based on attribute information and content information of the script sample;
training a script generation model to be trained based on the video frames in the video samples, the prompt information sample, and the script sample, so that the script generation model to be trained learns a mapping relationship among the video frames in the video samples, the prompt information sample, and the script sample.

19. The non-transitory storage medium according to claim 18, wherein the training a script generation model to be trained based on the video frames in the video samples, the prompt information sample, and the script sample comprises:
inputting the video frames in the video samples and corresponding prompt information samples into the script generation model to be trained, and obtaining a predicted script output by the script generation model to be trained;
calculating a loss value between the predicted script and the script sample;
in response to the loss value not satisfying a model training end condition, adopting a backpropagation method to adjust model parameters of the script generation model to be trained.

20. The non-transitory storage medium according to claim 15, wherein the script generation model comprises a visual encoder and an adapter, and parameters of the adapter are updated during training of the script generation model;
the generating, by the script generation model, a video feature sequence according to video frames in the original video, mapping the video feature sequence to a text feature space of the script generation mode, and obtaining a video mapping feature sequence comprises:
compressing the video frames in the original video by the visual encoder to obtain a feature vector, and generating the video feature sequence according to the feature vector corresponding to the video frames;
mapping the video feature sequence to the text feature space by the adapter to obtain the video mapping feature sequence.
